(19) United States
(12) Patent Application Publication
(10) Pub. No.: US 2025/0234944 A1
(43) Pub. Date: Jul. 24, 2025

(54) FLUIDIZED BED DIP COATING AND ARTICLES MADE THEREFROM

(71) Applicants: Sebastian Scientific Solutions LLC, Upland, CA (US); SmartHealth, Inc., Phoenix, AZ (US)

(72) Inventor: Sebastian S. Plamthottam, Upland, CA (US)

(73) Assignees: Sebastian Scientific Solutions LLC, Upland, CA (US); SmartHealth, Inc., Phoenix, AZ (US)

(21) Appl. No.: 19/174,025

(22) Filed: Apr. 9, 2025

Related U.S. Application Data
(63) Continuation of application No. PCT/US2023/078265, filed on Oct. 31, 2023.
(60) Provisional application No. 63/421,864, filed on Nov. 2, 2022.

(51) Int. Cl. A41D 19/00; C09D 5/03; C09D 7/61; C09D 7/63; C09D 167/04

(52) U.S. Cl. CPC A41D 19/0055; C09D 5/035; C09D 7/61; C09D 7/63; C09D 167/04

(57) ABSTRACT

The present disclosure relates to plasticized polymer compositions and a process for forming plasticized polymers. The process involves first coating the substrate with a plasticizer containing layer by dip coating. A powder layer of polymer is coated over it using a fluidized bed of polymer powder by dip forming process. The process involves cryogrinding the polymer pellets to below about 500 micrometer size particles, preferably below about 100 micrometer size particles, fluidizing the particles with or without fluidizing additives, by suspending the particles in air, by flowing air in a controlled manner upwards in a column resulting in an air solid suspension. The process can be used to make dip formed articles and dip coated substrates. This environmentally friendly process can be applied to bioplastics to make ecofriendly articles.

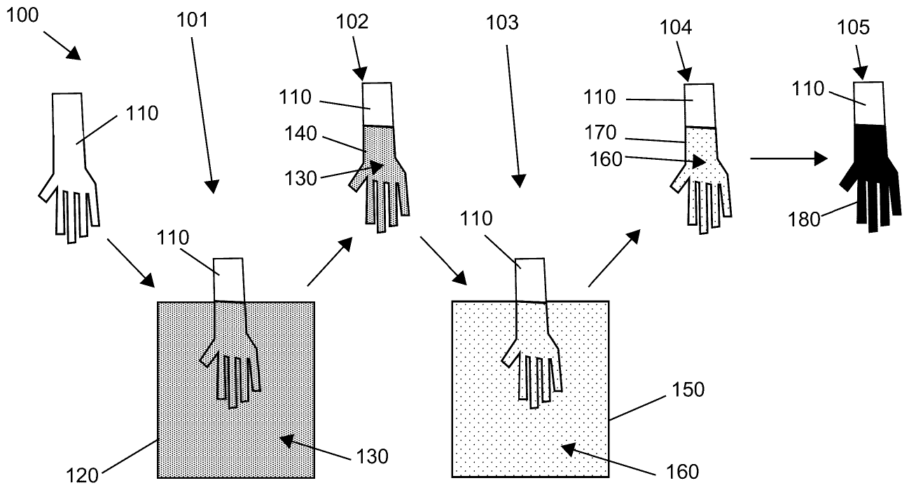

### CROSS-REFERENCE TO RELATED PATENT APPLICATIONS

This patent application is a continuation of co-pending U.S. Patent Application No. PCT/US2023/078265, filed Oct. 31, 2023, which claims the benefit of U.S. Provisional Patent Application No. 63/421,864, filed Nov. 2, 2022, the entire teachings and disclosure of both of which are incorporated herein in their entireties by reference thereto.

### FIELD

The present application relates to fluidized dip forming process suitable for use in producing dip formed articles and dip formed substrates made of a plasticized polymer. In particular, the present application relates to dip formed articles and dip formed substrates and films made of plasticized polylactide, lactic acid copolymers, polysuccinates, polycaprolactones, polyhydroxyalkanoates, starch derivatives, and blends of the above polymers and other biodegradable polymers.

### BACKGROUND

Articles such as surgical gloves, examination gloves, household gloves, cleanroom gloves, isolator box gloves, industrial gloves, electrical gloves, catheters, finger cots, teats, pacifiers, soothers, swim caps, balloons, football bladders, and the like are all normally made by a dip forming process from solutions or dispersions of natural or synthetic polymers. A form of the appropriate shape is dipped into the solution or dispersion of the compounded emulsion or solution or plastisol, once or multiple times, to build a layer of desired thickness. Forms are normally rotated or moved in a specific controlled manner to obtain the desired distribution of material around the former without forming any pin holes or defects. The water or solvent if present is then allowed to evaporate, and in some cases, the film after drying is cured to obtain a solid elastomeric film with adequate mechanical properties. The article is then stripped from the mold or former.

Such production processes are not environmentally friendly. In most cases, dip forming requires the evaporation of solvent or water, releasing volatiles into the atmosphere, and high energy usage is required to drive the solvents and water from the coating. Almost all gloves and condoms are currently commercially produced by this process. In view of recent concerns about global warming resulting from ozone layer depletion, significant attention now is focused on changing the manufacturing processes to environmentally friendly processes and on changing the materials to environmentally friendly renewable bio-sourced biodegradable materials.

Gloves are manufactured from many types of polymers such as natural rubber (NR), nitrile butadiene rubber (NBR), polychloroprene (CR), polyisoprene (IR), polyurethane, chlorosulfonated polyethylene (CSM), styrenic block copolymers, polyvinyl chloride, etc. Disposable gloves are normally made from polymers such as natural rubber (NR), synthetic polyisoprene (IIR), polychloroprene (CR), poly (acrylonitrile-co-butadiene) copolymer (NBR or nitrile rubber), polyurethanes, and the like. While compounded natural rubber latex is widely used to make surgical gloves, examination gloves, condoms, catheters, etc., it has many drawbacks such as, for example, the presence of Type I and Type IV allergens, poor aging, and sometimes disagreeable odor. To address the Type I allergen issue, compounded neoprene, nitrile, and polyisoprene synthetic emulsions are widely used to make surgical and examination gloves. Typically, gloves used in medical, dental, cleanrooms, and food handling are thrown away after a single use, and this causes a significant environmental challenge since all the above materials used to make the gloves are not compostable or biodegradable.

Polylactide (PLA), also known as polylactic acid, is an environmentally friendly biodegradable alternative to petroleum-based polymers. Polymer materials that can be used for gloves need to be soft, flexible, strong, and conformable. This limits the use of PLA for glove type application because PLA is rigid, and suitable plasticizers need to be employed to soften the material for glove application. In addition, these plasticized polymers need to be processable in glove manufacturing equipment by a dip forming process. Even though PLA can be made into a solution or emulsion or dispersion for dip forming, the process is more difficult compared to other natural or synthetic lattices, since producing small particle PLA is energy intensive and also difficult since PLA is commercially available in pellet form and not easy to grind or convert to particles having a size of a few micrometers. In addition, this process requires the removal of solvent or water to form the glove. Such a process is energy intensive and not very eco-friendly.

### BRIEF SUMMARY

Embodiments of the present disclosure provide improved plasticized compositions for thin-walled articles. In one or more particular embodiments, the present disclosure provides improved PLA compositions for gloves and an improved glove forming process for plasticized polymers based on PLA. The process involves first coating a substrate, such as a glove former, with the plasticizer or a solution of PLA in plasticizer by dip coating. A powder layer of PLA is coated over the plasticizer layer using a fluidized bed PLA powder dip forming process. The process involves cryogrinding the PLA pellets to particles having a size below about 500 micrometers, preferably below about 100 micrometers. The particles are then fluidized using a fluidizing bed, which involves suspending the particles in air and flowing air in a controlled manner upwards in a column resulting in an air solid suspension. This air solid suspension behaves like a fluid, which can be used to dip form articles such as gloves. The glove former is then heated to fuse the polymer powder over the plasticizer film layer into a composite plasticized PLA film. In one or more embodiments, the composite plasticized PLA film may be described as a PLA polymer matrix in which the plasticizer is absorbed. The dip formed article can then be released from the mold after cooling.

Such a process gives pinhole-free films suitable for making dip formed articles from large sizes PLA particles (having a particle size of up to a few hundred micrometers) and avoids the use of solvent or water in the process. In this way, the process is environmentally friendly. The material is also renewable, bio-sourced, and biodegradable. The plasticizer used in the process is also renewable, bio-sourced, and biodegradable. Thus, all the material components and the process used to make the article are environmentally friendly.

Fluidized powder coating has been used in making coated products. For example, U.S. Pat. No. 4,434,126, the contents of which are incorporated herein in their entirety by reference thereto, describes a fluidized bed powder coating process for making polyurethane surgical gloves by applying first a powder of urethane pre-polymer, melting it on a heated former, and then applying another powder coat. The '126 patent does not teach how to make a plasticized polymer coated product or a glove made from a bioplastic or a hydrocarbon polymer using a fluidized bed powder coating process.

In contrast to conventional processes, the present disclosure provides a fluidized bed dip forming process that can be used for plasticized films. According to embodiments of the present disclosure, the plasticized films include one or more plasticizer layers. In embodiments, the plasticizer layer can be applied as a first layer or as a second layer. Preferably, the plasticizer is applied as a first layer.

In one or more embodiments of the presently disclosed fluidized bed powder dipping process, the fluidized bed temperature is maintained below the tack temperature of the polymer particles to avoid agglomeration of the polymer particles in the fluidized bed. Further, in one or more embodiments, fluidization aids or additives such as silica, aluminum hydroxide, calcium oxide, or aluminum silicate, among others can be added to facilitate the fluidization process. In such embodiments, the fluidization aid or additive may be added during the cryogrinding process of the polymer.

Embodiments of the present disclosure provide a fluidized bed powder coating process to make plasticized polymer gloves, specifically plasticized biodegradable gloves. The biodegradable polymers include renewable, and bio-degradable polymers such as polylactide, lactic acid copolymers, polysuccinates such as poly(butylene succinate) (“PBS”), poly (butylene succinate-co-butylene adipate) (“PBSA”) and the like, polycaprolactones, polyhydroxyalkanoates, starch derivatives, and blends of the above polymers. PLA polymers include polymers of lactic acid or lactide with repeating units of L-lactide, D-lactide, or meso-lactide, or R or S lactic acid and/or S lactic acid monomers.

The polymer can be amorphous, crystalline, or a mixture of both depending on the application. For glove-type applications, it is preferred that the polymer is amorphous in the upstretched state at ambient temperature. Such polymers are available from Nature Works LLC under the name Ingeo 4060D and Ingeo 6302D and the like. It is preferable that the polymer or polymer blend crystallizes under high deformation to achieve high tensile strength. Other polymers can also be used in this process, in particular those that can be made into a powder form and that can be fluidized and can be plasticized, and it is preferable that the plasticizer be highly compatible with the polymer, which can in the process form a composite blend during the film fusion process at high temperature.

The fusion temperature depends on the softening point of the polymer plasticizer blend. For Ingeo 4060D, the fusion temperature is at or above about 125° C. The fusion temperature can be higher if the PLA is crystalline and can be as high as over 180° C. depending on the D isomer content. The fusion temperature depends on the D isomer content of the PLA. At about 10% D isomer content, the fusion temperature is about 125-135° C. At about 4% D isomer content, the fusion temperature is about 145-160° C., and at about less than 0.5% D isomer, the fusion temperature is about 170-180° C.

For making PLA gloves, plasticizer for the first layer dip coating can be any highly compatible plasticizer for PLA. There are many plasticizers that can be used with PLA such as polypropylene glycol, polyethylene glycol, fatty acid esters, citrate or adipate esters, triethyl citrate, tributyl citrate, acetyl triethyl citrate, acetyl tributyl citrate, lactide monomer, oligomeric lactic acid, epoxidized soybean oil, adipates, diesters, and the like. Many plasticizers commercially available from Proviron Holdings NV (Hemiksem, Belgium), Roquette Freres (Lestrem, France) and Condensia Quimica Inc. (Barcelona, Spain) such as Proviplast 2512, Proviplast 25422, Proviplast 01422, OLA-2, OLA-8, 206/3NL, isosorbide diesters, Polysorb ID 46, Polysorb ID 37 and the like can also be used. According to a particular embodiment, a preferred plasticizer for this process to make gloves is Proviplast 25422 for Ingeo 4060 D and Ingeo 6302D polymer powder which provide rapid fusion and high compatibility and stability during aging of the films. Although many plasticizers are available for PLA, very few are suitable for use in making glove-type films, and Proviplast 25422 and Proviplast 01422 are particularly suitable for this purpose.

### BRIEF DESCRIPTION OF THE DRAWING

The accompanying drawing incorporated in and forming a part of the specification illustrates several aspects of the present invention and, together with the description, serves to explain the principles of the invention. In the drawing:

The FIGURE is a flow diagram of a process for dip-forming a thin-walled polymer product, according to an exemplary embodiment.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The term “dip forming” or “dip coating” refers to the process in which thin-walled polymer products are produced. As used herein, the term “thin-walled polymer products” refers to elastomeric articles (such as, but not limited to, gloves, condoms, balloons, catheter balloons, catheters, dental dams, finger cots, teats, and the like) having a thickness in the range from about 0.001 mm to about 5 millimeters or larger for thicker articles. For disposable gloves, in particular, the thickness of the thin-walled polymer products is in a range of about 0.05 mm to 0.2 mm, in particular about 0.1 mm.

As shown in the FIGURE, the dip forming process 100 involves a first step 101 of first immersing a former 110 in the shape of the desired article into a first tank 120 of plasticizer or a polymer in plasticizer 130. Formers 110 can be made from ceramic, glass, aluminum, and the like. The former 110 at ambient or elevated temperature is dipped into a plasticizer or polymer in plasticizer 130, and in a second step 102, the former 110 is subsequently slowly withdrawn from the liquid plasticizer 130 at ambient temperature or at elevated temperature to form a thin coat 140 of the plasticizer 130 on the former 110. The thickness of the thin coat 140 can be controlled by the temperature, texture of the mold, viscosity of the plasticizer, and dipping and withdrawal speed. The viscosity of the plasticizer can be adjusted by temperature or by dissolving the PLA into the plasticizer at or above ambient temperature. The formers can have a release coating if desired or can use a fluorocarbon, such as Teflon (PTFE), coated on the former. Many such release agents and coatings are known in the art.

In a third step 103, the former 110 having the thin coat 140 of the plasticizer 130 is then immersed into a fluidized bed 150 of PLA particles 160 preferably at or below ambient temperature (23° C.) to form a substantially uniform coating 170 of the powder 160. The uniformity of the uniform coating 170 can be controlled also by vibrating the former 110. After withdrawing the former 110 having the uniform coating 170 of powder 160 from the fluidized bed 150 in a fourth step 104, the former 110 having the uniform coating 170 of powder 160 is then heated to a temperature above the fusion temperature of the coating 170 to form a pin hole free film 180 in a fifth step 105. In one or more embodiments, the fusion temperature is at least about 100° C., in particular at least about 120° C. A release coating can be applied to the fused film for easy stripping of the product from the former 110. The former 110 is then cooled to ambient temperature and the product stripped from the former 110. This process can be carried out by a batch process or as a continuous process such as on a chain line for making gloves.

The term “Fluidized bed” refers to particles of polymer or a mixture of polymers having sizes ranging from sub-micrometers to several thousand micrometers suspended by air flowing upwards through a porous membrane in a column or tank forming an air solid suspension with or without fluidizing additives so that the air solid suspension behaves like a fluid.

The term “Biodegradable” refers to a product that can pass ASTM D 6400 Standard Specification for Labeling of Plastics designed to be Aerobically Composted in Municipal and Industrial facilities and can be certified by an independent agency such as the Biodegrdable Products Institute (BPI).

The term “PLA” refers to polymers or copolymers of lactic acid or lactide

The term “Hydrocarbon polymers” refers to chlorosulfonated polyethylene (CSM), ethylene propylene copolymers such as EPM or EPDM, polyethylene, isobutylene isoprene rubber, styrenic block copolymers, and blends of these polymers and the like.

As used herein, the term “styrenic block copolymer” (hereafter designated as “SBC”) refers to a linear triblock (A-B-A type) or radial block or multi arm block copolymer (AB) n type where A is predominantly the hard, high glass transition temperature (Tg) polystyrene segment, and B is predominantly the low Tg rubbery or elastomeric segment. A is normally known as the end blocks and B as the mid blocks. If the elastomeric segment is polybutadiene, the SBC linear triblock is named poly(styrene-b-butadiene-b-styrene) or SBS for short, and if the elastomeric mid-block is polyisoprene, then this SBC linear triblock is named poly(styrene-b-isoprene-b-styrene) or SIS for short. The mid-block is unsaturated in SBS or SIS. The elastomeric mid-block can be saturated as in poly(styrene-b-ethylene/butylene-b-styrene) hereafter designated SEBS, poly(styrene-ethylene/propylene-styrene), hereafter designated SEPS, poly(styrene-b-ethylene/ethylene-b-styrene), hereafter designated SEES.

“Thermoplastic gel” as used herein refers to a solution comprising plasticizer and polymer or copolymer, which forms a homogenous liquid solution at elevated temperature and a gel at near ambient and lower temperatures. “Gel” refers to a soft solid similar in texture to “gello pudding” that does not flow under gravity but can deform under gravity at ambient temperature. “Thermoplastic” refers to flow characteristics more like a liquid or polymer solution at elevated temperature, the viscosity and temperature at which it starts flowing depending on the composition of the blend.

“A plasticizer containing layer” refers to a layer which predominately comprises a plasticizer or a blend of plasticizers with or without other additives.

“Bioplastic” refers to polymers produced from renewable biomass sources, such as sugar cane, corn starch, cassava starch, or beets, among other possibilities.

In one embodiment of the process, articles are made by dipping a release coated substrate, such as a former, in the plasticizer to form a layer of continuous liquid film of plasticizer on the substrate, withdrawing the substrate from the plasticizer, immersing this substrate into a fluidized bed of PLA particles, withdrawing the substrate from the fluidized bed, heating the substrate to fuse and compatibilize the plasticizer with the PLA, and stripping the article from the substrate after cooling. Optionally, a release agent or low friction coating can be applied before stripping. In one or more embodiments, the substrate is a former, such as a glove former having the shape of a hand.

In one or more embodiments, the substrate has a fluorocarbon coating such as Teflon to facilitate release of the article

In one or more embodiments, the plasticizer layer comprises a solution or dispersion of PLA in plasticizer.

In one or more embodiments, the plasticizer layer is a thermoplastic gel.

In one or more embodiments, the plasticizer layer comprises a predominantly crystalline PLA in plasticizer.

In one or more embodiments, the plasticizer layer is predominantly amorphous PLA in plasticizer.

In one or more embodiments, the plasticizer selected is biodegradable and highly compatible with the PLA.

In one or more embodiments, the plasticizer is an ethoxylated aliphatic diester.

In one or more embodiments, the plasticizer is bis(2-(2-butoxyethoxy)ethyl)adipate.

In one or more embodiments, the plasticizer contains a PLA hydrolytic stabilizer and a PLA crosslinking agent dissolved in the plasticizer.

In one or more embodiments, the PLA hydrolytic stabilizer is a carbodiimide, such as Stabaxol® 1 LF available from LANXESS Deutschland GmbH, Cologne, Germany.

In one or more embodiments, the PLA crosslinking agent is dicumyl peroxide in the range of from about 0.25 weight percent (wt %) to about 10 wt % in the plasticizer.

In one or more embodiments, the PLA powders comprises amorphous PLA.

In one or more embodiments, the PLA powder comprises fluidizing additives in addition to PLA particles.

In one or more embodiments, the fluidizing powder is a hydrocarbon polymer with or without fluidizing additives, and the plasticizer is compatible with a hydrocarbon polymer.

In one or more embodiments, the powder is a hydrocarbon polymer, and the plasticizer is a thermoplastic gel at ambient temperature.

In one or more embodiments, the powder is a blend of hydrocarbon polymers.

When required, radiopaque pigments, such as lead particles, lead oxide, barium sulfate, bismuth subcarbonate, bismuth trioxide, or bismuth oxychloride, among other possibilities, can be formulated into the dip molded articles by inclusion in the dip molding composition. Such radiopaque pigments make the molded articles detectable by X-Ray, and in higher proportions, the radiopaque pigments provide at least partial shielding to protect the user of the article. Full protection and shielding from X-Ray exposure will generally require additional protective measures, however, as the shielding afforded according to embodiments of the present disclosure will generally be only partial. Such ingredients may be particularly suitable for use in medical and surgical gloves worn in certain contexts.

In one or more embodiments, additives, such as antioxidants and ultraviolet stabilizers, hydrolytic stabilizers, crosslinking agents, colorants, or pigments, may be added to the formulations. Such additives can serve to substantially extend the service and shelf life of the finished article. These additives can be dissolved or dispersed in the plasticizer or, if the additive is in the form of a fine particle and fluidizable with the polymer, can be added in the fluidizing medium.

Additional additives, such as suitable biocides, biostats, flavors, fragrances, or deodorants, can also be included in the formulation if desired.

In one embodiment illustrated in the FIGURE, the process 100 can be employed to form an article such as a glove, catheter, or finger cot. The plasticizer 130 is placed in a dipping tank 120, and a clean former 110 in the shape of the article is dipped slowly into this solution. The temperature of the former 110 may be cool or warm. The formers 110 are optionally rotated or inverted up and down to distribute the coating 140 evenly on the surface of the former 110. Such rotation may not be necessary if the coating is a thermoplastic gel. The former 110 with the coating 140 of plasticizer 130 is then immersed in a fluidized bed 150 of polymer particles 160, a single time or multiple times. When immersed in the fluidized bed 150, the polymer particles 160 embed into or coat the layer of plasticizer 130 on the former. The former 110 having the coating 170 of polymer particles 160 over the coating 140 of plasticizer 130 is then heated to thermally fuse and compatibilize the plasticizer. The former 110 is then cooled, and then, optionally, a release coating can be applied before cooling and the article stripped from the former 110.

The components used to make a fluidizing dip tank 150 include a tank with an air chamber, fluidizing microporous membrane, such as porous polyethylene or craft paper, among other possibilities, to distribute the air into the chamber from the bottom of the tank. The set up also includes a controlled air supply to fluidize the powder 160 in the tank 150. In one or more embodiments, electrostatic charge can be used to assist the coating of the former.

In one or more embodiments, the process can be employed to coat a substrate such a fabric or metal part or a plastic. In this case the process involves coating the substrate with the plasticizer and then immersing the substrate into a fluidized bed of polymer particles and heating the substrate to thermally fuse the particles of polymer and plasticizer to form a plasticized film layer on the surface of the substrate.

Many types of materials with film properties from rigid, leathery, to soft and rubbery features can be made using these processes and compositions. For a biodegradable plastic like amorphous PLA, such as Ingeo 4060D and Ingeo 6302D, rigid plastic films and coatings on substrates can be made using less than about 10 weight percent (wt %) plasticizer, such as an ethoxylated aliphatic diester (e.g., Proviplast 25422). Leathery features result if the level is from about 15 wt % to about 25 wt %, and soft films result from about 25 wt % to about 50 wt %. At about 30 wt % to 35 wt % of plasticizer, features close to that of glove type films result. Such features are ideal for replacing plasticized polyvinyl chloride (PVC) type gloves using environmentally friendly compositions and processes.

A PLA composition using predominantly amorphous Ingeo 4060D containing 30wt % Proviplast 25422 exhibited a tensile strength of 11 MPa and elongation at break of 400%. Compositions made with 24 wt % Proviplast 25422 and 19 wt % Polycaprolactone (Capa 2077A) as another plasticizer exhibited a tensile strength of 13.2 MPa and elongation at break of 410%. All percentages are wt % of the total film material. Compositions made with Ingeo 6302 and 30 wt % Proviplast 25422 showed a tensile strength of 10 MPa and Elongation at break of 400%. All tensile strength measurements were performed according to ASTM D 1708.

The articles produced employing the compositions may be a single layer or multi-layered article. Multilayered articles can be formed by dipping a former in multiple fluidized beds of different polymers to form the respective layers. For example, it may be desirable to provide an article having an inner layer exhibiting a first property or characteristic and a second (or other additional layers) that provide other properties or characteristics to the article. In the case of a condom, for example, it may be desirable to provide an inner layer has relatively low lubricity to avoid slippage, while providing an outer layer that is more lubricious. In the case of gloves, it may be desirable to have an inner layer with a reduced friction relative to a wearer's skin, and an outer layer that may provide more tack or grip.

### EXAMPLES

Aspects and embodiments of the technology are further understood in reference to the following examples. The following examples are for illustrating aspects and embodiments of the technology and are not intended to limit the scope of the invention:

### Example 1

A Teflon coated ceramic former in the shape of a hand was dipped into a plasticizer (Proviplast 25422) to obtain a thin film of plasticizer on the surface. Fine powder of Ingeo 4060D about 100 micrometer average particle size was then fluidized by flowing air upward in a controlled manner through a constant fluidizing cylindrical dip tank 40centimeters in height and 20 centimeters in diameter fitted with a porous membrane. A constant airflow was maintained to keep the powder in fluidized state using an air flow controller. The plasticizer coated former was then immersed in the fluidized powder to obtain a uniform coating of powder on the former. The coated former was then heated to 140° C. for 10 minutes to fuse the powder plasticizer film. A bead was rolled when the film was warm and the glove stripped from the mold after cooling and coating with a release agent. The glove produced contained a plasticizer level of 32 wt % of the film material.

What has been described above include an example of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a dip formable composition, articles formed from such compositions, and methods of making articles using such compositions. Modifications may occur to those skilled in the art and to those who may make and use the invention. The disclosed embodiments are merely for illustrative purposes and not intended to limit the scope of the invention or the subject matter set forth in the claims.

What is claimed is:

1. A process of making a plasticized polymer film, comprising:
coating a first layer onto a substrate, the first layer comprising a plasticizer;
immersing the substrate into a fluidized bed of polymer particles such that the polymer particles coat the first layer;
withdrawing the substrate from the fluidized bed;
heating the substrate to fuse the polymer particles and form the plasticized polymer film on the substrate.

2. The process of claim 1, wherein the substrate is in a shape of an article and the plasticized polymer film is removed from the substrate after cooling to a temperature of within about 25° C. of ambient temperature and retains the shape of the article.

3. The process of claim 2, wherein the article is a glove, a condom, a catheter, or a finger cot.

4. The process of claim 1, wherein the first layer comprises a polymer dissolved or dispersed in the plasticizer.

5. The process of claim 1, wherein the first layer is a thermoplastic gel at ambient temperature.

6. The process of claim 1, wherein the first layer comprises at least one of a hydrolytic stabilizer or a crosslinking agent.

7. The process of claim 6, wherein the first layer comprises the hydrolytic stabilizer and wherein the hydrolytic stabilizer comprises a carbodiimide.

8. The process of claim 6, wherein the first layer comprises the crosslinking agent and wherein the crosslinking agent comprises dicumyl peroxide.

9. The process of claim 8, wherein the first layer comprises from about 0.25 wt % to about 10 wt % of the dicumyl peroxide.

10. The process of claim 1, wherein the fluidized bed of polymer particles comprises a bioplastic.

11. The process of claim 10, wherein the bioplastic is selected from a group consisting of a polylactide, a lactic acid copolymer, a polysuccinate, a polycaprolactone, a polyhydroxyalkanoate, a starch derivative, a lactic acid caprolactone copolymer, and combinations thereof.

12. The process of claim 10, wherein the bioplastic comprises a polylactide and wherein the polylactide is predominantly amorphous.

13. The process of claim 1, wherein the fluidized bed further comprises a fluidization additive selected from a group consisting of silica, calcium oxide, aluminum silicate, zinc oxide, aluminum hydroxide, and combinations thereof.

14. The process of claim 1, wherein the first layer comprises from about 5 wt % to about 50 wt % of the plasticized polymer film.

15. The process of claim 1, wherein the first layer comprises from about 25 wt % to 35 wt % of the plasticized polymer film.

16. The process of claim 1, wherein the plasticizer comprises at least one of ethoxylated aliphatic diester or bis(2-(2-butoxyethoxy)ethyl)adipate.

17. The process of claim 1, wherein the polymer particles comprise particles of hydrocarbon polymer.

18. The process of claim 17, wherein the hydrocarbon polymer is selected from a group consisting of chlorosulfonated polyethylene, an ethylene propylene copolymer, polyethylene, isobutylene isoprene rubber, a styrenic block copolymer, and combinations thereof.

19. The process of claim 1, wherein the polymer particles have a size of 500 micrometers or less.

20. A plasticized polymer film article made according to the process of claim 1.
